(19) United States
(12) Patent Application Publication
(10) Pub. No.: US 2004/0104814 A1
(43) Pub. Date: Jun. 3, 2004

(54) Method and apparatus for vehicle coupling

(76) Inventors: Henrik Thorning Christensen, Tsawwassen (CA); Jason Elliott, Richmond (CA); Bruce Stephen Jenner, North Vancouver (CA)

Correspondence Address: DORSEY & WHITNEY LLP, INTELLECTUAL PROPERTY DEPARTMENT, SUITE 3400, 1420 FIFTH AVENUE, SEATTLE, WA, 98101, US

(21) Appl. No.: 10/298,161

(22) Filed: Nov. 14, 2002

(51) Int. Cl. B60R 25/10

(52) U.S. Cl. 340/426.16

(57) ABSTRACT

An energy exchange network provides a coupling service to users of the network. Access to a user through an access controller is controlled initially by allowing only the coupling service to communicate with the user. Several wireless communications zones are established so that the vehicle can be identified and guided to effect coupling. The coupling service effects control of the physical connection of a user vehicle to the energy exchange network. Typically, other services are subsequently provided and a service is not given more access than needed at any point in the sequence, hence a user can only respond to the service currently connected and cannot access other services. The coupling service automates connection to the energy exchange network while protecting the network against unauthorized access. A security service is associated with the coupling service to provide various levels of security for users of the coupling service.

### FIELD OF THE INVENTION

The present invention relates to vehicle coupling and is particularly concerned with method and apparatus for automated vehicle coupling for energy exchange.

### BACKGROUND OF THE INVENTION

Alternative fuel vehicles have been discussed for a long time. One energy carrier that holds the promise of reducing emissions in urban areas is hydrogen. However using hydrogen as a fuel presents a number of difficult challenges both in vehicle propulsion systems and in the fueling infrastructure.

One concern with the use of hydrogen as fuel is safety in delivering fuel to vehicles operated by the general public because of a wide range in expertise. The ubiquitous self-serve gasoline stations have accustomed consumers to fueling their own vehicles and have proven economically attractive to station owners. Hence it is unlikely that a return to full service stations would gain wide acceptance.

### SUMMARY OF THE INVENTION

An object of the present invention is to provide an improved method and apparatus for vehicle coupling.

According to an aspect of the present invention there is provided an apparatus for coupling a vehicle to an energy exchange network comprising: a transceiver for communicating with a vehicle; and a service node controller for controlling communication between the service node controller and a vehicle.

According to an aspect of the present invention there is provided a method of coupling a vehicle to an energy exchange network the method comprising the steps of: initiating communication with a vehicle; identifying the vehicle from the communication; causing the vehicle to be positioned appropriately for coupling; and effecting physical coupling to the vehicle.

An advantage of the present invention is providing a vehicle coupling system that enables automated, quasi-automated or manual coupling to a vehicle and authenticates the vehicle, a user of the vehicle or both prior to providing services.

### BRIEF DESCRIPTION OF THE DRAWINGS

The present invention will be further understood from the following detailed description with reference to the drawings in which:

FIG. 1 illustrates in a system block diagram, a service terminal and a terminal-compatible vehicle, wherein liquid and gaseous fuels, water, electricity and data are exchangeable between the terminal and the vehicle;

FIG. 2 illustrates in a perspective view, a wheel stop service port of the service terminal in FIG. 1;

FIG. 3 illustrates in a perspective view, a connectivity device mountable to a vehicle;

FIG. 4 illustrates in an energy exchange network including a coupling system.

FIG. 5 illustrates a portion of the energy exchange network including a coupling system in accordance with an embodiment of the present invention;

FIG. 6 illustrates in a flow chart a coupling method in accordance with an embodiment of the present invention for the coupling system of FIG. 5;

FIG. 7 illustrates in a flow chart a coupling method in accordance with an embodiment of the present invention for the coupling system of FIG. 5;

FIG. 8 illustrates in a block diagram a coupling system in accordance with an embodiment of the present invention, implemented in a multi-port station;

FIG. 9 illustrates in a block diagram a coupling system in accordance with another embodiment of the present invention, implemented in a two-port service terminal for a residential use.

### DETAILED DESCRIPTION OF THE PREFERRED EMBODIMENT

An energy exchange system as described includes a service terminal for coupling vehicles to exchange energy services, the terminal including vehicle coupling hardware and connection to energy service provider systems, and an energy exchange network governing the control and management of energy exchange between the connected systems.

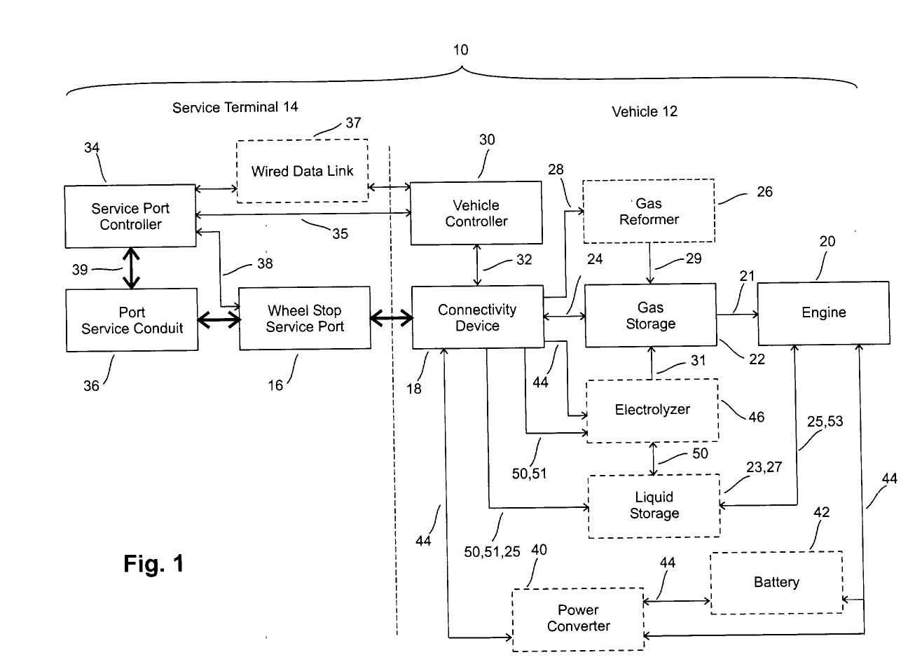

FIG. 1 illustrates an embodiment of a system 10 for transferring one or more of energy, material or data (collectivity referred to as “services”) between system-compatible vehicles 12 and a stationary service terminal 14. The service terminal 14 may be integrated into a building or pre-existing structure, or be part of a dedicated vehicle service terminal facility or be part of a mobile vehicle service port. In each embodiment, the service terminal 14 has a wheel stop service port 16 and the vehicle 12 has a connectivity device 18 that can couple to the wheel stop service port 16. Other major components of the service terminal 14 include a service port controller 34 for controlling the transfer of services by the wheel stop service port 16, and a port service conduit 36 for coupling the service terminal to one or more service destinations (not shown). The destination may be a service source when the service is to be transferred from the source to the vehicle 12; for example, the service source may be a fuel tank that supplies fuel to the vehicle when coupled to the service terminal 14. Or, the destination may be a service consumer when the service is to be transferred from the vehicle 12 to the consumer; for example, the service terminal 14 may be connected to a power grid, and the consumer may be an electricity user connected to the grid that receives electricity generated by a fuel cell onboard the vehicle and transferred to the grid when the vehicle is connected to the service terminal.

The system 10 is particularly suitable for providing services to fuel cell and regenerative fuel cell vehicles, but can also serve vehicles powered by other means, such as natural gas, liquid fuels, electricity, etc. The vehicle 12 has a number of components that make it compatible with the service terminal 14; the type of components depend on what services are being transferred.

FIG. 1 illustrates an embodiment of a system 10 that is capable of transferring one or more of gaseous and liquid fuel, water, electrical energy and data between a service terminal 14 and a vehicle 12. The vehicle 12 may include some or all of the components as described in the systems illustrated in FIG. 1. The connectivity device 18 may include one or a combination of the service connections as described below. The wheel stop service port 16 has interfaces for at least gaseous fuel, liquid, electricity and data. The wheel stop service port 16 is suitable to work with the connectivity device 18 of any vehicle, regardless of the maximum number of service connections on the connectivity device 18. An additional function of the system 10 is that the type of connectivity device 18 and the type of service required is determined by communication between the vehicle controller 30 and the service port controller 34. The service port controller 34 provides control signals through the control signal wire 38 to the wheel stop service port 16 directly, or via control signal wire 39 and port service conduit 36 to control the transfer of only those services suitable for the identified connectivity device 18.

The connectivity device 18 is electrically communicative with a vehicle controller 30 via control signal wire 32, which controls operation of the connectivity device 18; for example, the vehicle controller 30 provides automatic connection and gas transfer control signals to control the transfer of gaseous fuel through the connectivity device 18. The vehicle controller 30 has a transceiver (not shown) to exchange data wirelessly with a transceiver (not shown) in a service port controller 34 of the service terminal 14 (wireless link shown as 35). The construction of the controllers 30, 34 are known in the art. Optionally, a wired data link 37 may be substituted for the transceivers; in such case, data line connection points (not shown) are provided on each of the wheel stop service port 16 and the connectivity device 18 that connect when the wheel stop service port 16 and the connectivity device 18 are coupled or alternatively data can be sent over the electrical power connections. The data communicated to and from the vehicle controller 30 relates to providing data-related services that include vehicle identification, and fueling processes.

The connectivity device 18 has a gas transfer port (not shown) that is sealably connectable to a gas transfer port (not shown) of the wheel stop service port 16 to enable the transfer of gas between the vehicle 12 and the service terminal 14. The connectivity device 18 is connected to a gas storage cylinder 22 by way of gas line 24. Gas line 24 is bi-directional to enable fuel to be transmitted from the service terminal 14 to the vehicle 12, or vice versa. The gas storage cylinder 22 is fluidly connected to the engine 20 by way of gas transfer line 21. In one embodiment, gaseous fuel is transferred and reformed so that constituents such as hydrogen gas can be stored on-board the vehicle. A gas reformer 26 is provided that is connected to the connectivity device 18 via gas line 28, and connected to the gas storage cylinder 22 via gas line 29, so that gaseous fuel transmitted from the wheel stop service port 16 can be first reformed before being stored in the gas storage cylinder 22 and used by the engine 20.

An embodiment of the service terminal is to provide the function of electricity transfer to or from the vehicle, for the purposes of powering onboard electrolysis or storage charging, and for transferring generated electricity from the vehicle back through the service terminal. In this case, the connectivity device 18 is configured to transmit electric power between the service terminal 14 and the vehicle 12, and the vehicle controller 30 is configured to control the transmission of electrical energy by the connectivity device 18. Electrical cables 44 electrically couple the connectivity device 18, power converter 40, battery 42, and the engine 20. Similarly, the wheel stop service port 16 is configured to transmit electric power between the service terminal 14 and the vehicle 12, and the service port controller 34 is configured to control the transmission of energy by the wheel stop service port 16.

A potential use of the service terminal is to transfer liquid fuel such as gasoline. The connectivity device 18 is configured to transfer liquid fuel between the service terminal 14 and the vehicle 12, and the vehicle controller 30 is configured to control the transmission of liquid by the connectivity device 18. Similarly, the wheel stop service port 16 is configured to transmit liquid fuel between the service terminal 14 and the vehicle 12, and the service port controller 34 is configured to control the transmission of liquid fuel by the wheel stop service port 16. A liquid fuel storage tank 23 and liquid fuel lines 25 are designed to store and transmit liquid fuel as known in the art.

The service terminal, in an embodiment, may transfer water or other liquids to the vehicle for onboard electrolysis for hydrogen generation. A fluid storage tank 27 is provided to store water transferred from the service terminal 14, an electrolyzer 46 is provided to electrolyze the water to produce hydrogen gas, and a gas storage cylinder 22 is provided to store the hydrogen gas for use by the engine 20. Hydrogen fuel lines 21 fluidly connect the gas storage cylinder 22 to the electrolyzer 46 and engine 20 respectively, and fluid supply and return lines 50, 51 fluidly connect the fluid storage tank 27 to the connectivity device 18 and the electrolyzer 46 respectively. Water is supplied to the vehicle 12 as hydrogen feedstock for the electrolyzer 46 via liquid supply line 50, and unused water from the electrolyzer 46 is returned through liquid return line 51. Water line 53 connects the fluid storage tank 27 to the engine 20 to return product water from the engine 20 and to supply water to humidify the gas stream. Both the connectivity device 18 and the wheel stop service port 16 are configured to transfer liquid and electricity between the service terminal 14 and the vehicle 12. Electrical cables 44 electrically connect the connectivity device 18 to the electrolyzer 46. The vehicle controller 30 is configured to control the operation of the connectivity device 18 to transfer water and electricity for the operation of the electrolyzer 46. The electrolyzer 46 is fluidly connected to the gas storage cylinder 22 through gas line 31.

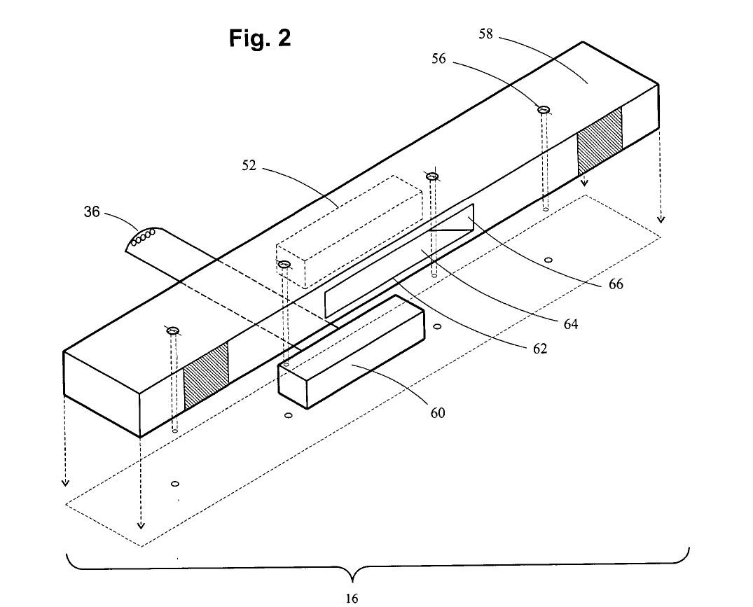

Referring to FIG. 2, the wheel stop service port 16 serves as a ground-mounted stationary docking location for vehicles 12 equipped with compatible connectivity devices 18. Such vehicles 12 couple to the wheel stop service port 16 and bi-directionally transfer services between the service terminal 14 and the vehicle 12. As mentioned, these services include electrical power, gaseous or liquid fuels, water or data. The wheel stop service port 16 is also designed to prevent the wheels of the vehicle 12 from traveling beyond a specific point in a parking stall and to locate the vehicle 12 in a position that places the vehicle's connectivity device 18 in a position for coupling to the service port 16. Other forms of service ports 16 may be used in the overall energy exchange network, including manual connections from service ports.

The wheel stop service port 16 has a generally elongate rectangular wheel stop housing 58 with fastening holes 56. The fastening holes receive a fastener (not shown) for fastening the service port 16 to a parking surface. Near the center of the front surface of the housing 58 is a recess opening 62 that opens into a receptacle recess 52. A connection bay 64 and a receptacle 60 are mounted inside the receptacle recess 52. The connection bay 64 has a front opening in the shape of a rectangular slot, and has tapered walls 66 that taper inwards both vertically and horizontally into the receptacle 60. The front opening of the connection bay 64 is flush with the recess opening 62. The receptacle 60 is mounted inside the receptacle recess 52 behind the connection bay 64 and also has tapered walls (not shown) that taper into the back wall of the receptacle. As discussed in detail below, the tapered walls 66 serve to guide a service plug 70 from the vehicle's connectivity device 18 into a coupling position inside the receptacle 60, i.e., into a position where the plug contacts the back wall of the receptacle.

In this description, the receptacle 60 and plug 70 are collectively referred to as a “service coupling”. Furthermore, the connection bay 64 and receptacle 60 are collectively referred to as the “connection bay assembly”.

The tapered walls 66 act to guide, or “self-locate” the plug 70 into a coupling position, thereby removing the need to provide costly electronic coupling guidance systems. It is understood that other self-locating designs such as a funnel may be substituted for the tapered walls 66 as will occur to one skilled in the art.

The service port 16 is externally controlled by the service port controller 34 via a signal conduit housed inside the service conduit 36. An externally controlled receptacle 60 allows system intelligence such as the service port controller 34 to be located elsewhere, enabling the service port 16 to be economically and easily replaced. Optionally, the service port 16 also has a port status indicator 52 located on the top surface of the housing 58.

The recess opening 62 is located on the front wall of the service port 16 but it may be located anywhere on the wheel stop housing 58. For example, the recess opening 62 may open from the top surface of the housing 58 such that the receptacle 60 and connection bay 64 receive a vertically deployed connectivity device 18.

The receptacle 60 is provided with service exchange interfaces that mate with corresponding service exchange interfaces on the plug 70 to effect a transfer of services therebetween. The service conduit 36 is coupled to the receptacle 60 at the back of the service port 16 and to service sources and/or destinations, thereby enabling the services to be transferred to and from the service port 14 and the service source/destination.

In an alternative embodiment, the service terminal 14 does not include the wheel stop service port 16 and in such case, a service port comprising the connection bay 64 and receptacle 60 are located elsewhere on the service terminal, and the corresponding location of the connectivity device 18 on the vehicle 12 of the alternative embodiment is at a position for coupling to the service port 16.

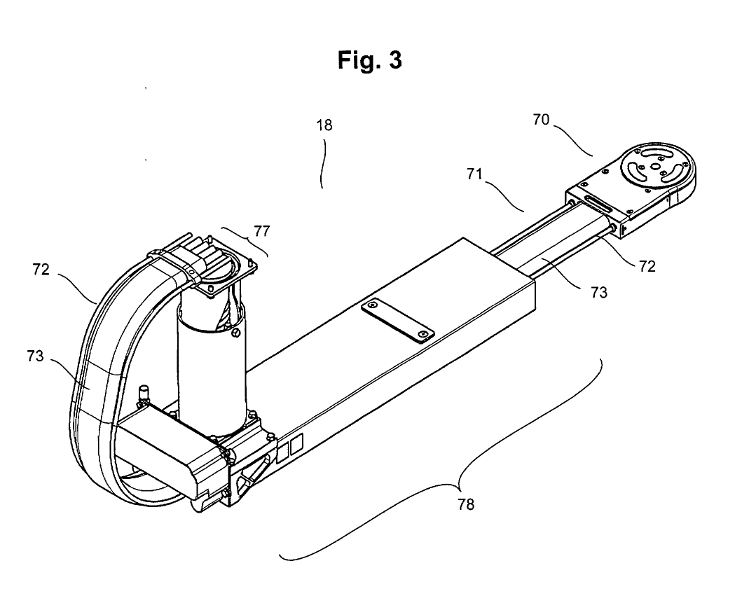

Referring to FIG. 3, the connectivity device 18 is for connecting the vehicle 12 to the service terminal 14 such that services can be exchanged therebetween. In this first embodiment, the connectivity device 18 is mountable to the front underside of the vehicle 12, includes a device to deploy the connectivity device from the vehicle, and has plug structures to couple to the receptacle 60 on the wheel stop service port 16 when the vehicle is in close proximity to the wheel stop service port. The major components of the connectivity device 18 are a plug 70 for coupling to the receptacle 60 of the service terminal 14, a compliant member 71 attached at one end to the plug, a deployment apparatus 78 attached to the compliant member for deploying the plug from a stored position into a deployed position and retracting same back into the stored position, and a vehicle mounting assembly 77 attached to the deployment apparatus 78 and mountable to the underside of the vehicle 12.

The compliant member 71 comprises a pair of flexible water lines 72 and flexible electrical cables 73 having a plurality of flexible electrical power conductors (not shown) housed within a protective jacket. The water lines 72 and the power conductors are coupled to components of the vehicle 12 that use or supply water and/or electricity. For example, the water lines 72 and electrical cables 73 may be connected to the on-board electrolyzer 46 to supply feedstock water and power the electrolyzer 46, respectively. Another option is that a hydrogen supply line is provided (not shown) for the purpose of direct fueling of the vehicle from a stored source of hydrogen.

In operation, the service coupling is engaged whenever the vehicle parks at a service port 16. The vehicle is typically parked at a service port 16 for fueling although it may also be parked to enable the transfer of information from or to the service port controller 34 and a network controller (not shown in the figures). The plug 70 of connectivity device 18 is inserted into the receptacle 60 and is physically clamped in place by the clamp actuator (not shown) in the wheel stop service port 16. Typically the wheel stop service port 16 is fixed to the ground or parking structure and receives power from a fixed line. Thus the wheel stop service port 16 is able to physically fix the vehicle 12 in place independent of the vehicle power supply or vehicle engine systems. The docking process allows only an authorized user to unlock the docking mechanism. User authorization may be determined using a variety of techniques, such as: user ID and password; card and personal identification number (PIN); or biometric scan.

An alternative embodiment of the invention mounts the connectivity device 18 to a different part of the vehicle 12, or mounts the receptacle 60 to a different part of the service terminal 14. A further alternative embodiment locates the connectivity device 18 on the wheel stop service port 16, and locates the receptacle 60 on the vehicle 12; in such case, the connectivity device extends from the wheel stop service port to couple to the vehicle when the vehicle is in close proximity to the wheel stop service port.

In one form of the invention the wheel stop service port 16 is installed at the vehicle owner's residence such that the vehicle can be fueled overnight or can generate power while parked at a private residence.

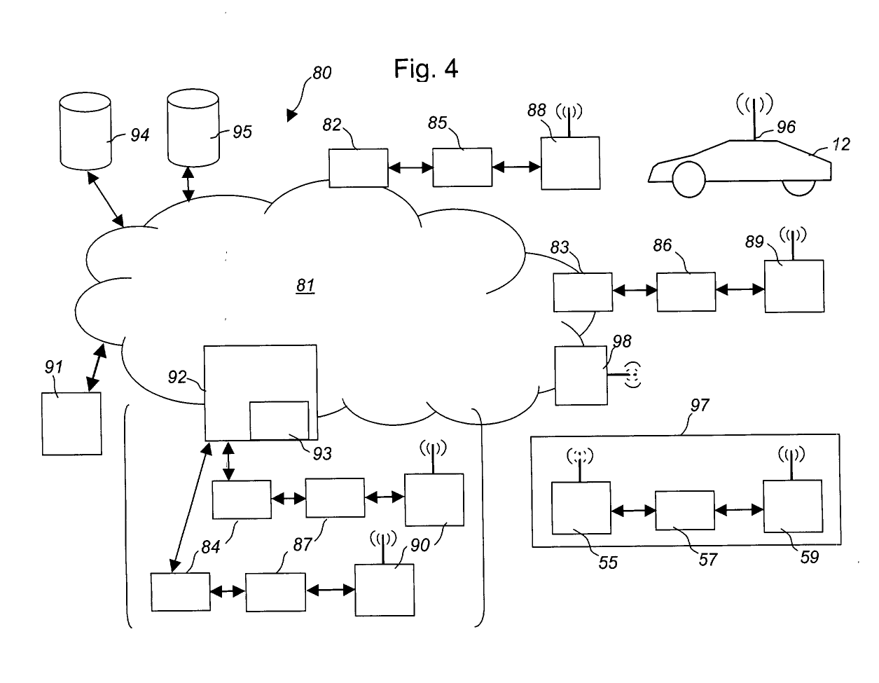

Referring to FIG. 4, there is illustrated an energy exchange network 80 including a coupling system in accordance with an embodiment of the present invention. The coupling systems are located at network nodes corresponding to service terminals 14 that include service port subsystems for communicating and coupling to vehicles 12 accessible to the network. An energy exchange station node controller 92 is located at energy exchange stations (not shown). An energy exchange station controls and manages multiple service ports 16 and coordinates network communications with individual service node controllers 82, 83, 84 at the service port. The station node controller 92 controls access to energy services and are connected to a plurality of service terminals 14 and enable management of local energy and services by the service terminals at that energy exchange station. An energy exchange network 80 includes a plurality of energy exchange network servers 91, a plurality of service node controllers 82, 83, 84, each coupled to an energy exchange network server via the wide area network 81. The wide area network 81 may include combinations of a private or public network, and technologies such as wireless, dialup, wired, satellite, broadband or internet systems. Service node controllers 82, 83 and 84 are coupled to access controllers 85, 86, 87, which in turn are coupled via node transceivers 88, 89, 90 to vehicles 12 provided with a corresponding communications transponder 96 or transponders 96. The access controllers 85, 86, 87 restrict services of their respective service node controllers 82, 83, 84 according to authorizations associated with potential users, such as a user corresponding to node transponder 96.

Each node transceiver 88, 89, 90 establishes a wireless local area network (LAN). Each node may be serviced by a single wireless LAN as illustrated in FIG. 4, or may have multiple wireless transceivers establishing multiple wireless LANs.

The energy exchange station node controller 92 is communicable with the service node controllers 84 associated with service terminals 14 located at the energy exchange station (not shown) and may control services provided through the associated service terminals, as well as local energy storage and distribution. In this example, the station node controller 92 communicates directly with the wide area network 81, and the service node controllers 82, 83, 84 communicate requests to the network through the station node controller. The station node controller 92 or individual service node controllers 82, 83, 84 may have a local cache 93 for storing authorization data and profiles, to enable services even when there is no connection to the network 81. The local cache 93 may include a database.

In either case, access to service node controllers 82, 83, 84 or via the wireless LAN is restricted by access controllers 85, 86, 87. Once the user corresponding to transponder 96 has docked the vehicle 12, a physical connection can optionally be established to support a data link between the access controller 85, 86, 87 and the transponder, consequently at least some of the ports can be accessed through a wired port in the vehicle coupling.

The energy exchange network server 91 provides energy services and management of distributed energy exchange transactions, manages transactions with energy service providers 94 and 95 (ESP) including buy and sell orders, and manages the energy exchange network 80 and service node controllers 82, 83, 84. Typically, a plurality of energy exchange network servers 91 is connected to the wide area network 81 to maintain a large scale of users and transactions. Data related to energy service providers 94 and 95 may be accessed via the energy exchange network 80 and the wide area network 81 and used to control buying and selling energy between the networked subsystems of the energy exchange network. An energy exchange network server 91 may include access to databases (not shown) for vehicle and user authentication and transaction data.

Users of the energy exchange network 80 may access the network through any of the energy exchange nodes or energy exchange network connections and may include ESP's, service providers, owners of service ports, vehicle owners and network managers.

In another embodiment, a mobile service node controller 55, similar in function to the above described stationary energy exchange service nodes, may be located in a mobile service port 97 to provide networked energy services. The function of the mobile service port 97 is to provide energy exchange, roadside support, fleet fueling, defueling, and emergency services to vehicles or other devices that require such services distant from a stationary energy exchange service system. In this embodiment, the wide area network 81 includes a second wireless network for mobile communications 98, which communicates wirelessly with the mobile service port 97 by way of a wireless connection with a mobile service node controller 55. The wireless connection between the network for mobile communications 98 and the mobile service node controller 55 is effected by commonly available mobile communications including cellular or satellite networks. The mobile service node controller 55 is in turn coupled to a mobile access controller 57, which in turn is coupled via mobile node transceiver 59 to vehicles 12 provided with corresponding communications transponder 96 or transponders 96. The mobile service port 97 includes an automated service port 16 that is automated, and optionally a service port with manual connection.

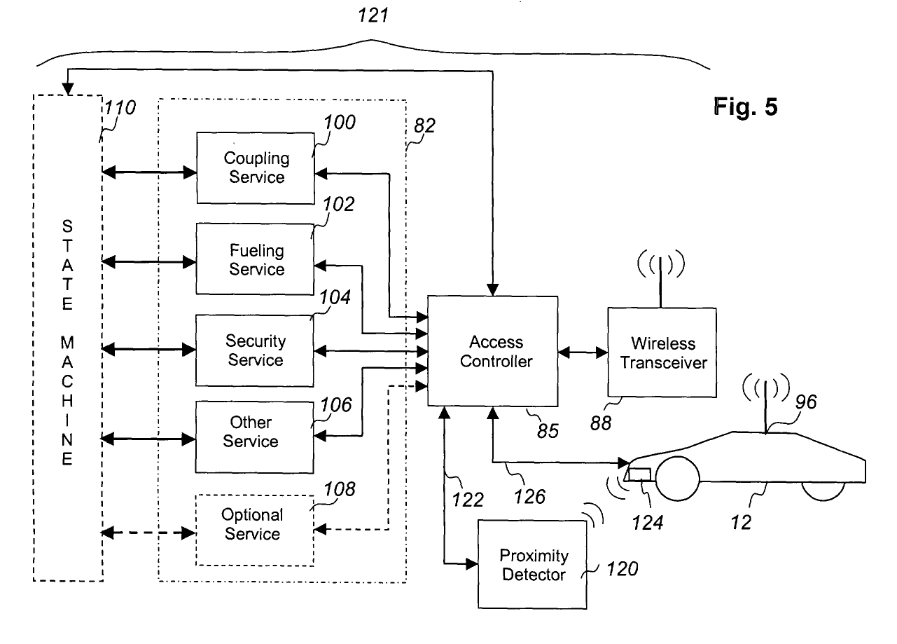

Referring to FIG. 5, there is illustrated a coupling control system 121 for the energy exchange network 80 of FIG. 4. The coupling control system 121 includes a service node controller 82, an access controller 85, and a node transceiver 88. The service node controller 82 includes a plurality of services 100, 102, 104, 106 and 108. The access controller 85 is coupled to the node transceiver 88 for communications with a user vehicle 12. The coupling control system 121 also includes a state machine 110 coupled to the service node controller 82 and the access controller 85. The state machine is instantiated by the energy exchange network 80 and may be resident in any appropriate processor, however, for the present example a local instantiation is considered. A proximity detector 120 is also coupled to the access controller 85 via a link 122 for detecting a proximate vehicle 12 via its proximity transponder 124. Once coupled, the vehicle 12 can establish an additional data link 126 to the access controller 85.

In operation, as a user vehicle 12 enters communication range of node receiver 88, the user vehicle's communication transponder 96 alerts the node transceiver 88. The node transceiver 88 communicates with the access controller 85. The initial information communicated is an identification of the user vehicle 12. The access controller 85 effects the change in the state machine 110, allowing the coupling service 100 to initiate communications with the user vehicle 12. Each of the services controlled by the service node controller may only be initiated by the state machine 110 and are not responsive to direct commands from the user vehicle 12. Hence, the role of the access controller 85 is to mediate between the service node controller 82 and the user vehicle 12 whether communicating wirelessly as is initially the case or, following coupling, communicating via a direct data link.

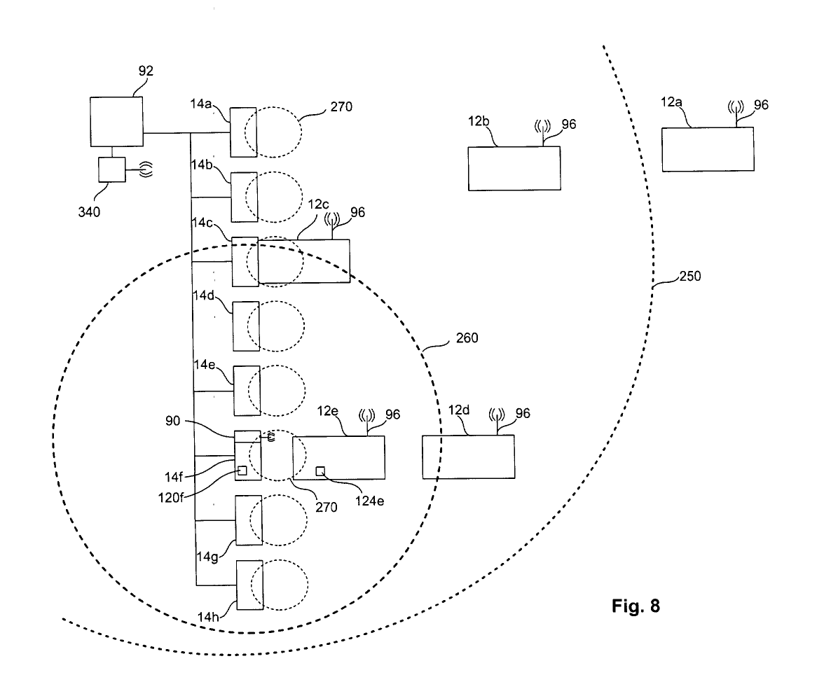

After initial identification of the vehicle 12, communication is provided to direct the vehicle 12 to a specific stall as shown in FIG. 5, or to inform the vehicle of available stalls as shown in FIG. 8. Each such stall is provided with a service port, for example a wheel stop service port 16. As the vehicle 12 approaches the wheel stop service port, signals emitted by the proximity detector 120 cause the proximity transponder 124 of the vehicle 12 to emit a reply signal. The proximity detector emits a radio frequency (RF) signal having a predetermined radiation pattern shaped to facilitate proper positioning of the vehicle. The proximity transponder 124 of vehicle 12 is responsive to the signal and replies with a return message that, in its simplest form, merely alerts the proximity detector to the presence of vehicle 12 within the radiation pattern of the proximity detector 120. Additional information may also be provided by the return message, such as a unique identification number for the vehicle 12. In the present example, the unique identification number is compared with the identification provided via the wireless transponder 96, as part of an authorization process performed by the coupling service 100.

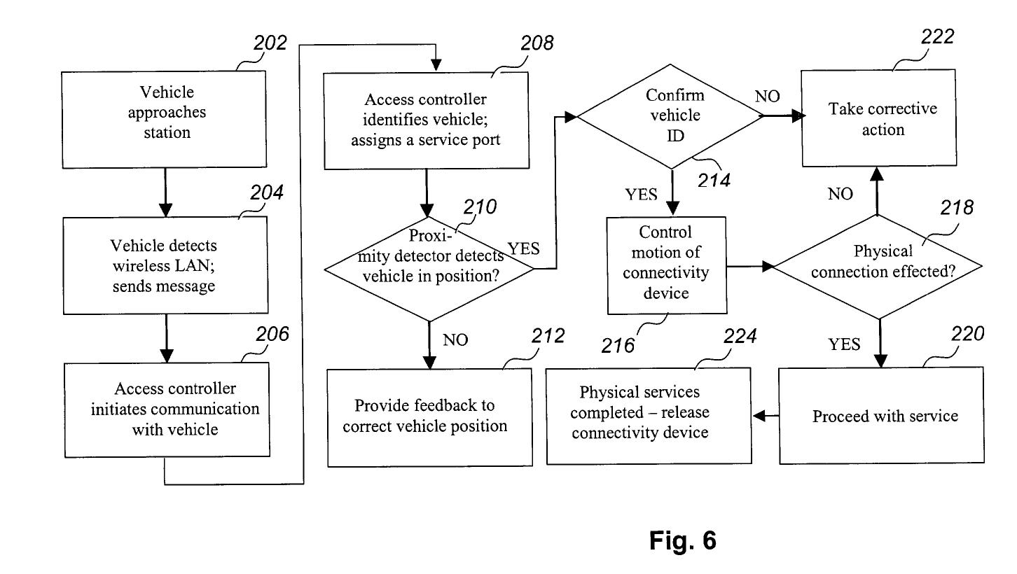

Referring to FIG. 6 there is illustrated in a flow chart of the coupling service 100 in accordance with an embodiment of the present invention. A user vehicle approaches a station as represented by a process block 202. As the node transceiver 88 sends out signals at regular intervals, a user vehicle 12 equipped with a transponder 96 sends a reply, or if equipped with a transceiver, detects the node transceiver signal and responds With a message as represented by a process block 204. In response to the message from the user vehicle 12, the access controller 85 initiates communication with the user vehicle 12, as represented by a process block 206. The access controller 85 uses the identification information of the message from the user vehicle 12 to identify the vehicle; and the coupling service 100 assigns a service port 16 for the vehicle 12 to dock with as represented by a process block 208. At this point, the coupling service 100 assumes control, with the access controller 85 continuing to monitor communication between the user vehicle 12 and the coupling service 100. The coupling service 100 relies upon the proximity detector 120 to query the position of the user vehicle 12 as represented by a decision block 210. When not in position for docking, for example no reply message is received by the proximity detector 120, feedback is provided to the vehicle 12 to correct the vehicle position, as represented by a process block 212. The form of the feedback can be either instructions to the driver for manual positioning, or instructions to the user vehicle 12 for automated positioning. Once the user vehicle 12 is correctly positioned and parked, confirmation of the vehicle identification is provided based upon the unique identification number received in the reply message from the vehicle's proximity transponder 124, as represented by a process block 214. When confirmed, the coupling service 100 controls the movement of the connectivity device 18 of the user vehicle 12, as represented by a process block 216. Sensors in the wheel stop service port 16 provide feedback to the coupling service 100 allowing it to determine whether physical connection has been effected as represented by a decision block 218. The physical connection includes proper positioning and physical securing of the port and vehicle such as a controlled clamping system (not shown). If yes, other services can then proceed as represented by a process block 220. Such services can include fueling service 102, security service 104, as well as other services 106, 108. If physical connection has not been effected, corrective action is taken, as represented by a process block 220.

An alternative process to the station selection of the user port, is one in which the user vehicle selects an unused service port to approach for service coupling, and the access controller uses the identification information of the message to track the user position and determine when it can be pre-associated with the user selected port. Then, the coupling service 100 assumes control, with the access controller 85 continuing to monitor communication between the user vehicle 12 and the coupling service 100. Once the proximity detector 120 senses the user vehicle 12 is correctly positioned and parked, and verifies the vehicle identity 214, the coupling service 100 controls the movement of the connectivity device 18 of the user vehicle 12, as represented by a process block 216. Sensors in the wheel stop service port 16 provide feedback to the coupling service 100 allowing it to determine whether physical connection has been effected as represented by a decision block 218. The physical connection includes both proper positioning and physical securing of the port and vehicle such as a clamping system (not shown) controlled by the coupling service 100. If yes, other services can then proceed as represented by a process block 220. Such services can include fueling service 102, security service 104, as well as other services 106, 108. If physical connection has not been effected, corrective action is taken, as represented by a process block 220, and can include port and vehicle status and diagnostic tests.

If the identity of the vehicle 12 is not confirmed at the decision block 214, corrective action is taken as represented by the process block 220. Such corrective action may be dependent upon a user profile for the vehicle corresponding to the unique identification number or it may follow a default procedure. In either case security procedures are invoked that may physically secure the vehicle or disable the vehicle until identity issues are resolved. All of these procedures are provided by the security service 104.

The user vehicle 12 may be equipped with other communications devices (not shown) that can be used in concert with the wireless communications at appropriate times during the process described with regard to FIG. 6. For example, the proximity transponder 124 of user vehicle 12 may include a radio frequency identification device (RFID) that uses a separate RF channel from that used by the wireless LAN to communicate with the proximity detector to send identification messages including the unique identification number discussed herein above. The user vehicle 12 may also be equipped with a data communications device (not shown) coupled to the connectivity device 18 for exchanging data while physically coupled via link 126to the energy exchange service port 16. These additional communication devices may be used to monitor the vehicle presence near the port, for example the proximity detector 120, or as a communication path 124 to allow the vehicle controller 30 to provide preferences or instructions to the access controller 85. These additional communications devices are connected to the access controllers in a similar configuration as the node transceivers.

The energy exchange service port 16 may include sensors such as proximity devices 120 to sense the presence of a user vehicle 12 in a service stall (not shown) or near the energy exchange service port. The sensor measurement may include a further unique identification code that may be transferred to the access controller 85 as an input to any of the services 100, 102, 104, 106, 108.

The purpose of the access controller 85 is to allow access to the energy exchange network resources provided by the service node controller 82. The services within the service node controller 82 act as trusted applications that act as proxies for the users as represented by user vehicle 12. It is the site services that are allowed access to the users, rather than the users that are allowed access to the site services.

In operation, the access controller 85 controls all access allowing only the appropriate level of access to proceed uninhibited. At any moment only access to the services required to support a current state of the energy exchange transaction is allowed through. Hence, once physical connection between the connectivity device 18 of the user vehicle 12 and the wheel stop service port 16 has been effected, the access controller 85 passes control to another associated service via the state machine 110.

Once all authorized services operated by the access controller are terminated, the access controller concludes the physical service connection as represented by step 224, including releasing the vehicle and port, such that the vehicle is free to start-up and drive from the port vicinity. The wireless connection/port is maintained with the vehicle until the vehicle is outside of communication range. The vehicle, while within range can re-dock to another port or request additional services through the LAN connection.

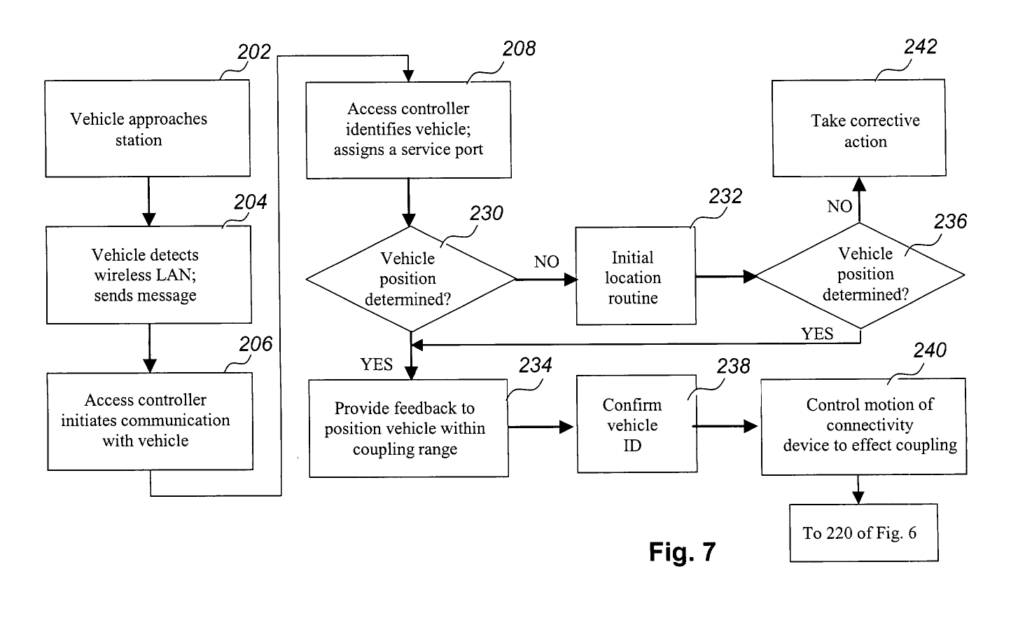

Referring to FIG. 7, there is illustrated a coupling method in accordance with an embodiment of the present invention. The method of FIG. 7 is similar to that of FIG. 6, with the addition of vehicle position determination steps. The vehicle position determination is queried, as represented by a decision block 230. When so determined, the access controller 85 provides guidance feedback to one of the port or vehicle controllers 34, 30 to guide the user vehicle 12 to a selected port as represented by a process block 232. When the vehicle position has not been determined, an initial location routine is run, as represented by a process block 234. The vehicle position determination is once again queried, as represented by a decision block 236 and if the user vehicle 12 is found to be correctly positioned, the process returns to the block 232.

This is followed by confirming the identification of the vehicle as represented by a block 238 and controlling deployment of the connectivity device 18 to effect coupling as represented by a process block 240. The process then passes to the process block 220 of FIG. 6. If the vehicle 12 is still not in position after the process block 236, corrective-action is taken as represented by a process block 242.

The access controller 85 provides guidance feedback to one of the port or vehicle controllers 34, 30 to guide the user vehicle 12 to a selected port, as represented by a process block 240. Alternatively, the user vehicle can steer towards any available service port and the coupling service can wait until a proximity detector 120 for the user selected service port senses the presence of a vehicle, the confirm vehicle identification step 238 can then be used to identify the vehicle with the user selected port.

When the user vehicle 12 is sensed by the proximity detector 120 to be in coupling range position, a signal is provided back to the coupling service 100 via link 126 to the access controller 85 as represented by process block 234 and the vehicle identity is confirmed at a block 238, the physical coupling is initiated as represented by process block 2240.

Referring to FIG. 8, there is illustrated in a block diagram a coupling system in accordance with an embodiment of the present invention implemented with a multi-stall station. The station includes a station node controller 92 and a plurality of service terminals 14a through 14h. The station also includes a first wireless transceiver 90a for establishing a first wireless LAN within a first zone 250 encompassing the entire station and a second wireless transceiver 90b for establishing a second wireless LAN within a second zone 260 encompassing a portion of the station, thus requiring further wireless transceivers (not shown) if full coverage is desired. The first and second wireless LANs can be organized hierarchically with hand-offs from one to the other as appropriate, they can both operate to provide different services or they can cooperate to handle different portions of the services provided. The plurality of service terminals each includes a third wireless transceiver housed in the proximity detectors 120a through 120h for establishing a plurality of third wireless zones 270.

The operation of the coupling system, in the context of the multi-stall station of FIG. 8 is described with reference to vehicles 12 in various positions, for the present example, as though there represent a single vehicle approaching the station, for ease of description. However it should be appreciated that the coupling system is also capable of handling a plurality of vehicles in a plurality of positions as shown in FIG. 8.

In operation, a vehicle 12 approaches the station from a position outside the first zone 250, as represented by a vehicle 12a. As the vehicle continues to approach the station, for example heading toward a vacant service terminal 14b, the vehicle enters the zone 250 and a first level of communication is established by the coupling service between the station node controller 92 and the vehicle 12b using the communications provided by the first wireless transceiver 90a. At this point either the coupling system directs the vehicle to an available service terminal 14 or the user vehicle selects a service terminal. For the present example, the former will be described. The vehicle is directed to service terminal 14f and as the vehicle approaches as represented by a vehicle 12d, the vehicle enters the second zone 260, thereby effecting communication with the second wireless transceiver in the second wireless LAN. When the second wireless LAN is used for other services, the coupling service continues to communicate via the first wireless LAN. If first and second LANs are organized hierarchically, such that the first LAN dealt with station-wide communications and the second LAN dealt with communications for a smaller group of service terminals, the coupling service would provide a handoff from the first to the second LAN, then continue communicating via the second LAN. Alternatively the LANs could cooperate, so that different functions within a service were handled by different LANs.

Whichever LAN is currently responsible for communications then provides the vehicle 12d with instructions on how to dock the vehicle, service menus and promotional information. So that the vehicle can be brought into a position within the third zone 270 proximate to the desired service terminal, as represented by a vehicle 12c and service terminal 14f. Once within the third wireless zone 270, a short-range transceiver within the proximity detector 120f listens for a response from the corresponding vehicle transponder 124e of vehicle 12e. From signal strength thresholds, angle of arrival and other signal characteristics, the proximity detector makes a determination whether the vehicle is in position for physical coupling. When the vehicle is insufficiently close, feedback is provided either to the driver in the case of manual docking or to the vehicle controller 30 for automated docking, or to both for semi-automated systems.

The proximity detector may also provide an additional level of vehicle identification by passing the vehicle identification number, provided by the proximity transponder 124c of vehicle 12e in a reply message.

Once sufficiently proximate to effect physical coupling as represented by a vehicle 12c, the coupling service initiates deployment of the connectivity device 18 as described herein above. When physical contact is confirmed via sensors in the receptacle 60, the plug 70 of connectivity device 18 is clamped in position. Clamping is necessary to insure fluid communication with the service port 14c, as well as electrical power and data communications connections.

Prior to offering services to the vehicle 12c, further authentication steps may be performed by the security service 104 such as user identification through known techniques, for example password, personal identification number (PIN) or biometrics. The security service compares inputs received to user profile data registered for the vehicle and/or user.

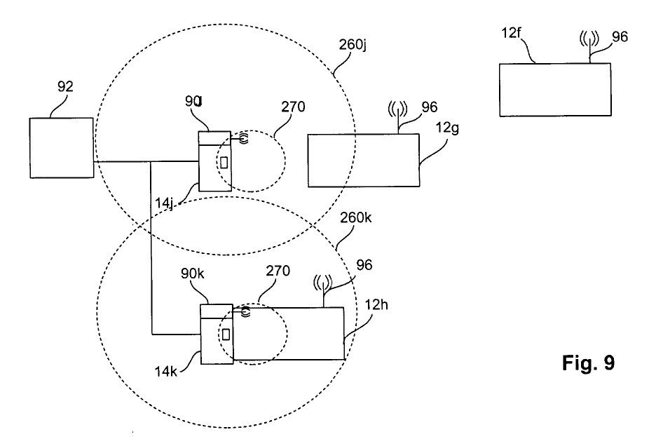

Referring to FIG. 9, there is illustrated in a block diagram a coupling system in accordance with an embodiment of the present invention implemented with a two-stall residential configuration. The residential configuration includes a home node controller 92 and a pair of service terminals 14j and 14k, each having a wireless transceiver 90j and 90k and a proximity detector 120j and 120k. The wireless transceivers 90j and 90k have a limited range, so that their respective zones 260j and 260k do not overlap where a vehicle enters their respective stall or parking space.

Operation is similar to the station of FIG. 8, put requires a less complex configuration due to having only two stalls.

In operation, a vehicle user first decides in which space to park as represented by a vehicle 12f The vehicle then approaches the selected space, as represented by a vehicle 12g and in doing so enters zone 260j of the wireless transceiver 90j. The vehicle is then allowed to communicate as described above. The main difference here is that each service port 14 has its own transceiver, so no handoff or selection of service terminals is required, by the coupling service. The remaining coupling sequence is as described herein above.

Numerous modifications, variations and adaptations may be made to the particular embodiments of the invention described above without departing from the scope of the invention, which is defined in the claims.

What is claimed is:

1. Apparatus for coupling a vehicle to an energy exchange network comprising:
a service node controller including a coupling service and another service;
an access controller coupled to the service node controller for limiting access to service initiated access;
a first wireless transceiver coupled to the service node controller for establishing a wireless communications channel with a vehicle within a first zone;
a second wireless transceiver coupled to the access controller for establishing a proximity detection channel with the vehicle within a second zone itself within the first zone; and
a service port for physically coupling to the vehicle and coupled to the access controller.

2. Apparatus as claimed in claim 1 wherein the coupling service includes a vehicle identification module.

3 Apparatus as claimed in claim 2 wherein the vehicle identification module includes a first vehicle identification component for identifying a vehicle in the first zone.

4. Apparatus as claimed in claim 3 wherein the vehicle identification module includes a second vehicle identification component for identifying a vehicle in the second zone.

5. Apparatus as claimed in claim 4 wherein the second vehicle identification component is responsive to an identification message received by the second wireless transceiver.

6. Apparatus as claimed in claim 5 wherein the identification message includes a unique vehicle identification number.

7. Apparatus as claimed in claim 1 wherein the coupling service includes a service coupling clamping module for controlling physically clamping and releasing of the service port.

8. Apparatus as claimed in claim 7 wherein another service included in the service node controller is a security service.

9. Apparatus as claimed in claim 8 wherein the security service includes a module for disabling releasing of the service port.

10. Apparatus as claimed in claim 9 wherein the module for disabling is dependent upon vehicle identification.

11. Apparatus as claimed in claim 10 wherein the module for disabling is dependent upon a user profile associated with vehicle identification.

12. Apparatus as claimed in claim 1 wherein another service includes a fueling service.

13. A station for coupling vehicles to an energy exchange network comprising:
a station node controller for communicating with an energy exchange network;
a service node controller including a coupling service and another service;
an access controller coupled to the service node controller for limiting access to service initiated access;
a first wireless transceiver coupled to the service node controller for establishing a wireless communications channel with a vehicle within a first zone; and
a plurality of service terminals, each service terminals comprising:
a second wireless transceiver coupled to the access controller for establishing a proximity detection channel with the vehicle within a second zone; and
a service port for physically coupling to the vehicle and coupled to the access controller.

14. A residential arrangement for coupling vehicles to an energy exchange network comprising:
a service node controller for communicating with an energy exchange network and including a coupling service and another service;
an access controller coupled to the service node controller for limiting access to service initiated access; and
a service port for servicing a vehicle within a parking stall having a first wireless transceiver coupled to the access controller for establishing a wireless communications channel with the vehicle within a first zone within the parking stall;
a second wireless transceiver coupled to the access controller for establishing a proximity detection channel with the vehicle within a second zone itself within the first zone; and
a service port coupled to the access controller for physically coupling to the vehicle.

15. A method of coupling a vehicle to an energy exchange network the method comprising the steps of:
initiating communication with a vehicle in a first zone;
identifying the vehicle from the communication;
detecting the vehicle in a second zone;
providing feedback to cause the vehicle to be positioned appropriately for coupling; and
effecting physical coupling to the vehicle.

16. A method as claimed in claim 15 wherein the step of initiating communication includes the step of transmitting a first wireless signal to the vehicle.

17. A method as claimed in claim 16 wherein the step of initiating communication includes the step of the vehicle responding to the first wireless signal by sending a message in a reply signal.

18. A method as claimed in claim 17 wherein the step of identifying the vehicle includes the steps of receiving the reply signal, retrieving the message and comparing a first identifier contained therein with a list of vehicle identifiers.

19. A method as claimed in claim 18 wherein the step of detecting the vehicle in a second zone includes receiving a reply signal having a second identifier.

20. A method as claimed in claim 19 including the step of confirming vehicle identity by comparing first and second identifiers.
